(19) United States
(12) Patent Application Publication
(10) Pub. No.: US 2026/0289959 A1
(43) Pub. Date: Sep. 24, 2026

(54) LANGUAGE-GUIDED FEATURE MATCHING FRAMEWORK INCORPORATING DOMAIN-INVARIANT SEMANTIC INFORMATION FROM VISION-LANGUAGE MODELS (VLMS)

(71) Applicant: Honda Motor Co., Ltd., Tokyo (JP)

(72) Inventors: Zhihao Zheng, Bethlehem, PA (US); Bo Lang, Bethlehem, PA (US); Nirav Bhagavanji Savaliya, San Jose, CA (US); Jinglun Feng, San Jose, CA (US); Zheng-Hang Yeh, Milpitas, CA (US)

(73) Assignee: Honda Motor Co., Ltd., Tokyo (JP)

(21) Appl. No.: 19/387,860

(22) Filed: Nov. 13, 2025

Related U.S. Application Data
(60) Provisional application No. 63/776,653, filed on Mar. 24, 2025.

(51) Int. Cl. G06V 10/74; G06N 3/0464; G06V 10/60; G06V 10/77

(52) U.S. Cl. CPC G06V 10/761; G06N 3/0464; G06V 10/60; G06V 10/7715

(57) ABSTRACT

A method for language-guided image matching using domain-invariant semantic information from vision-language models (VLMs) is provided. The method may generate instance-level textual queries using text embeddings, wherein each instance-level textual query acts as a class specific prototype to group and feature regions corresponding to a same class. The method may extract multi-scale visual features from illumination-invariant physical priors, fused with coarse-level features adapted from vision foundation models (VFMs).

### BACKGROUND

Robust image matching may be a foundational task in geometric perception, such as structure-from-motion (SfM), simultaneous localization and mapping (SLAM), and visual localization. Traditionally, image matching pipelines may be composed of discrete stages which may include key point detection, descriptor extraction, and feature correspondence. Many recent advancements have shifted towards learning-based approaches, which may demonstrate performance gains. Building upon this, recent work has focused on end-to-end trainable architecture, which may operate in dense or semi-dense schemes, and which may leverage architectural innovations such as transformer-based structures, cost-volume regularization, and coarse-to-fine strategies. Despite these efforts, many existing dense approaches may remain suboptimal, as these efforts may often rely on 3D supervision with expensive and limited ground truth data, which may struggle to generalize effectively the diverse challenges encountered in real-world scenarios.

The advent of vision foundation models (VFMs) and vision-language models (VLMs) may have introduced promising paradigms for achieving robust generalization across diverse computer vision tasks. VFMs like distillation of knowledge with no labels, version 2 (DINOv2) may produce spatially rich and semantically meaningful feature representations that may mitigate overfitting risks and exhibit strong transferability to unseen domains. Recent studies may have leveraged frozen VFM features as auxiliary inputs to guide coarse-level matching, which may improve robustness under challenging conditions. Nonetheless, two limitations may persist: unresolved domain gaps and reliance on unimodal visual representations. In contrast, VLMs may show strong generalization by incorporating semantic priors through text embeddings, offering domain-invariant and high-level contextual information. However, the potential of integrating language guidance into feature matching pipelines remains unexplored.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, a method for language-guided image matching using domain-invariant semantic information from vision-language models (VLMs) is provided. The method may generate instance-level textual queries using text embeddings, wherein each instance-level textual query acts as a class specific prototype to group and feature regions corresponding to a same class. The method may extract multi-scale visual features from illumination-invariant physical priors, fused with coarse-level features adapted from vision foundation models (VFMs).

According to an embodiment of the disclosure, a method for language-guided image matching using domain-invariant semantic information from VLMs is provided, the method implemented using a computer system including a processor communicatively coupled to a memory device. The method may generate instance-level textual queries using text embeddings of class names and learnable prompts, wherein each instance-level textual query acts as a class specific prototype to group and feature regions corresponding to a same class. The method may extract multi-scale visual features from illumination-invariant physical priors, fused with coarse-level features adapted from VFMs, the VFMs are calibrated for the coarse-level feature extraction using a LoRA mechanism. The method may enhance the coarse-level features to compute a matching probability distribution via a language-guided module, wherein coarse correspondences are selected using mutual nearest neighbor matching. The method may refine a position for each coarse-level feature match by evaluating feature similarity between a query patch and a localized search window.

The method may generate instance-level textual queries using text embeddings of class names and learnable prompts, wherein each instance-level textual query acts as a class specific prototype to group and feature regions corresponding to a same class. The method may extract multi-scale visual features using a CNN based FPN from illumination-invariant physical priors fused with coarse-level features adapted from VFMs, the VFMs are calibrated for the coarse-level feature extraction using a LoRA mechanism that inserts trainable low-rank matrices into each layer of the VFM allowing adaptation of the coarse-level features. The method may enhance the coarse-level features to compute a matching probability distribution via a language-guided module, wherein coarse correspondences are selected using mutual nearest neighbor matching. The method may refine a position for each coarse-level feature match by evaluating feature similarity between a query patch and a localized search window. The method may generate a day-night matching benchmark having synthetic day-night image pairs with ground-truth poses, to enable evaluation of model robustness under differing illumination changes.

### BRIEF DESCRIPTION OF THE DRAWINGS

FIG. 1 depicts an exemplary language-guided feature matching framework incorporating domain-invariant semantic information from vision-language models (VLMs) in accordance with an embodiment of the disclosure;

FIG. 2 depicts an exemplary low-rank adaptation learning scheme for VFMs for use in the framework of FIG. 1 in accordance with an embodiment of the disclosure; and

FIG. 3 depict exemplary qualitative comparison between the present method and other coarse-to-fine methods in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Reference will now be made in detail to specific aspects or features, examples of which are illustrated in the accompanying drawings. Wherever possible, corresponding, or similar reference numbers will be used throughout the drawings to refer to the same or corresponding parts.

To address the above observations and limitations, the present system and method may propose TextFM, a language-guided image matching framework that may incorporate domain-invariant semantic priors derived from VLMs. Built on the detector-free architecture of local feature transformer (LoFTR), TextFM may utilize text embeddings of class names and learnable prompts to generate instance-level textual queries. Each query may act as a class-specific prototype to group and highlight the regions corresponding to the same class. Unlike previous visual-only approaches, which may be sensitive to appearance variations, textual guidance may offer semantic consistency due to the intrinsic domain invariance with large pretrained VLMs. This integration may allow for more precise and robust correspondence estimation, especially in challenging conditions such as low texture surfaces, repetitive patterns, or unseen domains.

Furthermore, the proposed framework may incorporate robust visual features derived from illumination-invariant physical priors, which may be fused with coarse-level features adapted from VFMs. Unlike previous approaches that may rely on direct usage of visual features from frozen VFM backbones, the proposed framework may adopt the low-rank adaptation (LoRA) mechanism to fine-tune VFMs for coarse feature extraction. Specifically, the proposed framework may inject trainable low-rank matrices into each layer of the VFM, which may enable task-specific adaptation while preserving the large pre-trained knowledge. This approach may reduce the number of trainable parameters and avoid overfitting, which may offer a more effective and scalable way to tailor VFM feature representations.

Further, the absence of high-fidelity matching datasets for the evaluation of model robustness and generalization across varying illumination conditions has been recognized. Given the high cost of collecting real-world data with ground-truth 3D supervision, Megadepth-Sync may be introduced, a synthetic day-night matching benchmark which may be created by translating images from the public MegaDepth dataset into dark domains using a state-of-the-art image-to-image translation model. This dataset may enable a more rigorous assessment of feature matching methods under extreme lighting variations, which may provide a valuable resource for benchmarking real-world robustness.

Thus, the present framework may be summarized as follows:
A system and method, TextFM, may provide a language-guided image matching framework that may integrate domain-invariant semantic priors from textual embeddings into a detector free, coarse-to-fine semi-dense matching pipeline. By introducing instance-level textual queries derived from VLMs, TextFM may enhance coarse feature discriminability and may improve estimation robustness under domain shifts and challenging visual conditions.
The present framework may extract robust visual features derived from illumination-invariant physical priors, fused with coarse-level features adapted from VFMs. A LoRA-based adaptation scheme may be adopted for more adept task-specific fine-tuning VFMs while preserving pretrained knowledge, which may improve generalization and reduce overfitting compared to prior approaches that may directly fuse frozen VFM features.
The present framework may provide Megadepth-Sync, a day-night matching benchmark with high-quality synthetic day-night image pairs with ground-truth poses, which may enable rigorous evaluation of model robustness under extreme illumination changes. Extensive experiments may show that the proposed TextFM not only consistently outperforms state-of-the-art semi-dense feature matching methods across domains but yields improvement on day-night shifts.

Feature matching has traditionally followed a sparse paradigm which may involve keypoint detection and descriptor matching using handcrafted or learned features. While effective in well-textured scenes, such methods may fail in low-texture or repetitive regions due to limited keypoint repeatability. To address this, detector-free approaches have emerged, which may replace keypoint detection with coarse-level dense matching followed by mutual nearest neighbor filtering and refinement. These methods may improve robustness by leveraging global context through dense features. In contrast, dense matching frameworks may aim to establish pixel-level correspondences by estimating dense flow fields. While both paradigms may provide advanced matching performance, both remain limited to visual-only cues and may struggle under severe appearance variations or domain shifts, motivating exploration into semantically guided or cross-modal matching strategies.

Recently, foundation models may represent a new paradigm in deep learning, wherein large-scale models may be pretrained on large amounts of unlabeled data to learn general-purpose, transferable representations that may be adapted to a variety of downstream tasks. This approach, originally established in natural language processing (NLP), has been successfully extended to the visual domain, giving rise to a few VFMs. Notable examples may include contrastive language-image pre-training (CLIP), which may employ contrastive learning on large-scale image-text pairs to align visual and textual embeddings in a joint multimodal space; masked auto encoder (MAE), which may introduce masked image modeling (MIM) to learn latent visual representations by reconstructing occluded patches from visible context; and segment anything model (SAM), which proposes a promptable segmentation model trained across heterogeneous datasets for general purpose image understanding. EVA may further enhance visual representation learning by unifying MIM with CLIP-style embeddings. DINOv2 may adopt a self-distillation strategy without the need for labeled data, learning semantically rich and spatially aware features through teacher-student training.

Vision-language models (VLMs) trained on large-scale image-caption pairs collected from the web, have attracted significant attention for their ability to capture rich semantic relationships across modalities. CLIP may introduce a contrastive language-image pretraining framework that may align visual and textual embeddings in a shared latent space, which may enable strong zero-shot generalization. Its robustness to natural distribution shifts has been extensively studied. Building upon CLIP, EVA02-CLIP may integrate masked image modeling which may enhance the quality of dense visual representations, which may improve both semantic fidelity and spatial resolution for downstream vision tasks.

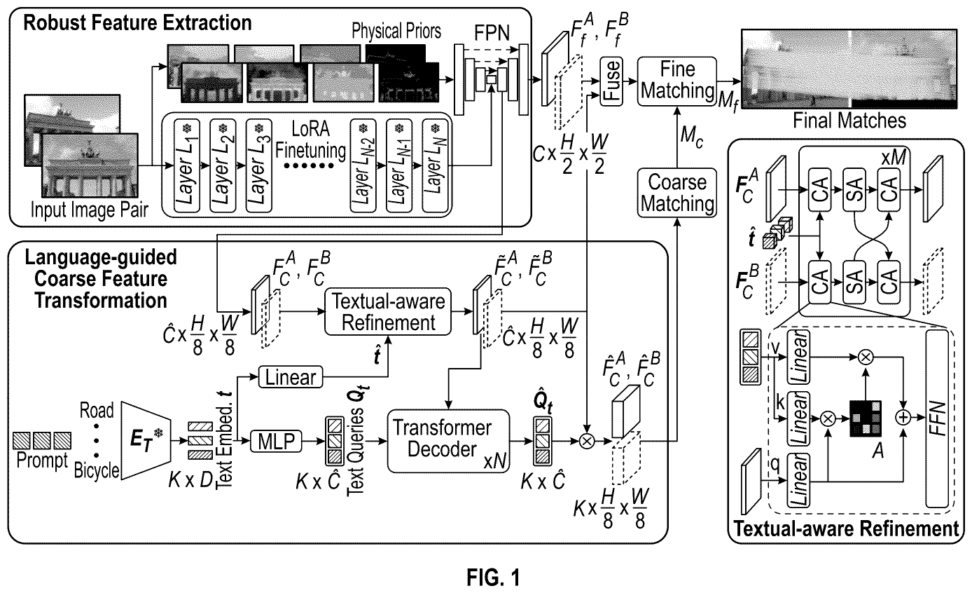

As shown in FIG. 1, the problem of estimating accurate correspondences between a pair of images may be addressed by employing a coarse-to-fine feature matching pipeline. Given a pair of input images I_{A} and I_{B}, robust multi-scale dense features

$$\{ {F}_{c}^{A} , {F}_{f}^{A} \} and \{ {F}_{c}^{B} , {F}_{f}^{B} \}$$

may be extracted using a simple convolutional neural network (CNN) based featured pyramid network (FPN) with physical priors and VFMs. The coarse-level features

$${F}_{c}^{A} , {F}_{c}^{B}$$

may be enhanced to compute a matching probability distribution via a language-guided module, from which coarse correspondences Mc may be selected using mutual nearest neighbor (MNN) matching. These coarse-level matches may then be refined using the finer-resolution features F_{f}, following the strategy introduced in EfficientLoFTR. Specifically, for each coarse match, the refined position may be obtained by evaluating feature similarity between a query patch

$${F}_{f}^{A}$$

and a localized search window in

$${F}_{f}^{B} .$$

This hierarchical approach may enable accurate fine-level matching M_{f} at high resolution while maintaining computational efficiency suitable for real-time applications.

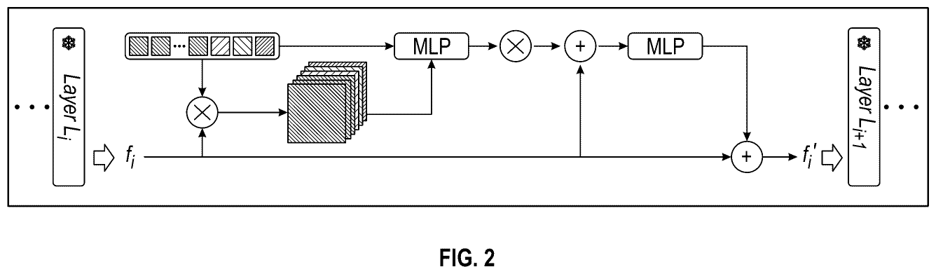

Integrating features from VFMs may provide more robustness to changes in viewpoint compared to conventional convolutional backbones. However, prior approaches that incorporate frozen VFM features as auxiliary visual representations may fall short of fully exploiting the generalization capabilities of VFMs, particularly in challenging cross-domain settings. On the other hand, fully fine-tuning VFM backbones, typically built on vision transformers (ViTs), may be computationally expensive and prone to overfitting, which may often result in losing pre-trained knowledge. To address this trade-off, a low-rank adaptation (LoRA) strategy may be adopted (in FIG. 2), which may introduce a trainable low-rank matrices into each layer of the VFM. This approach may enable efficient adaptation of coarse-level features while maintaining the integrity of the pretrained VFM parameters.

Given a VFM with N layers L₁, L₂, . . . , L_{N}, each layer may be associate with a pretrained weight matrix Wᵢ∈R^{c×c}. The feature representation at layer Lᵢ may be denoted as fᵢ∈R^{c×c}, where n may be the number of input patches and c may be the channel dimension. For the first layer, the features may be computed as f₁=W₁x, where x may represent the image embeddings.

To enable adaptation while preserving the pretrained parameters, a learnable residual matrix ΔWᵢ∈R^{c×c} may be introduced, such that the feature propagation from layer Lᵢ to Lᵢ₊₁ may be given by:

$${f}_{i + 1} = {W}_{i} {f}_{i} + Δ {W}_{i} {f}_{i} \qquad ( 1 )$$

To reduce parameter overhead, ΔWᵢ may be represented by using a low-rank decomposition: ΔWᵢ=BA, where A∈R^{r×c} and B∈R^{r×c} with rank r<<c.

Building upon this, one may propose a more efficient formulation by replacing ΔWᵢ with a learnable token Tᵢ∈R^{m×c} and a lightweight MLP Mᵢ(⋅). The feature update may become:

$${f}_{i + 1} = {W}_{i} {f}_{i} + {M}_{i} ( {T}_{i} {W}_{i} {f}_{i} ) \qquad ( 2 )$$

where m may be the token length. This modification may significantly reduce dimensionality, which may mitigate the curse of dimensionality and may enable stronger associations between tokens and image instances.

Thus, low-rank adaptation may be applied with Tᵢ=AᵢBᵢ, where Aᵢ∈R^{m×r} and Bᵢ∈R^{r×c}, with r<<min(m, c). This formulation may maintain computational efficiency while enabling effective task-specific adaptation of the VFM.

Learning coarse features from LoRA-adapted VFMs may improve generalization in cross-domain matching, particularly under moderate domain shifts. However, VFMs may inherently lack the capacity to preserve fine-grained spatial details which may be essential for precise fine-level matching. Moreover, certain challenging scenarios (e.g., day-to-night variations) can exceed the generalization limits of VFM representations. To address these shortcomings, illumination invariant physical priors may be generated from the input images and extract multi-scale visual features using a Feature Pyramid Network (FPN).

Given an input image I, a color invariant edge detector may be adopted to extract domain invariant priors {H, C, W}, which may be derived from Kubelka-Munk theory for material reflections. The estimated color invariant priors do not rely on accidental scene properties such as lighting and viewing direction and may depend only on the material property. The RGB color order map O may be added as an additional physical prior. All four priors may be concatenated as the input embeddings for the following FPN network. Within the FPN, the LoRA-adapted VFM features at deeper stages of the network may be fused to enhance both semantic robustness and spatial fidelity. The intermediate ⅛ down-sampled coarse features Fc and fine features F_{f} in ½ resolution may be extracted for later coarse-to-fine matching.

In coarse-to-fine feature matching pipelines, the coarse-level stage may play a pivotal role in determining the final matching accuracy, as it may establish the initial geometric correspondences. Features at this stage may be derived from deeper layers of the visual backbone and thus may encode higher-level semantics compared to fine-level features, which may be more spatially localized but less semantically informative. This may make the coarse level an ideal stage for incorporating language guidance, as semantic cues may enhance feature discriminability and robustness. To this end, a language-guided coarse feature transformation module may be proposed composed of three key components: textual query generation, which may derive semantic prompts from text embeddings; text-aware feature refinement, which may inject contextual semantics into pixel-level features; and contextual alignment, which may ensure semantic consistency for the following matching supervision.

Textual Query Generation: A pre-trained VLM (e.g., CLIP) may be utilized as the text encoder E_{T} to generate textual embeddings. The encoder E_{T} may be kept frozen during training to retain the contextual semantic and generalization capabilities of the pretrained language model. To better adapt the textual representations to matching task, a prompt learning strategy may be adopt, in which a learnable prompt p may be appended to each class label token [C L Sₖ], rather than relying on manually crafted prompts (e.g., “a photo of”, “a painting of”). Then, the text embeddings

$$t = {\{ {t}_{k} \}}_{k = 1}^{K} ∈ {R}^{K \times D}$$

may be computed as:

$${t}_{k} = {E}_{T} [ p , {CLS}_{k} ] ) \qquad ( 3 )$$

where K may be the total number of classes, and D may denote the channel dimension of text embeddings t. Then, a multi-layer perceptron (MLP) may be used to project the text embeddings t to textual queries Qₜ∈R^{K×Ĉ}, where Ĉ may be the channel dimension of textual queries Qₜ.

Textual-aware Feature Refinement: Coarse-to-fine feature matching pipelines typically may incorporate attention mechanisms to refine coarse features and improve geometric correspondence. In particular, the coarse features

$${F}_{c}^{A}$$

$$and$$

$${F}_{c}^{B}$$

may be progressively refined through M layers of interleaved self- and cross-attention blocks, resulting in enhanced representations

$${\tilde{F}}_{c}^{A}$$

$$and$$

$${\tilde{F}}_{c}^{B}$$

To improve the generalization capability of coarse features, textual-aware feature refinement may be introduced, which may enhance the semantic context of each pixel feature by integrating text embeddings through cross-attention before each self- and cross-attention block. This process may enrich pixel representations with domain invariant semantics, making them more effectively aligned and grouped by their corresponding textual queries.

One may start by generating textual prototypes \hat{t}∈R^{K×Ĉ} by projecting the original text embeddings t∈R^{K×D} through a linear layer. During textual-aware refinement, another cross-attention block may be applied, where layer normalized coarse features fᵢ∈R^{L×Ĉ} may be linearly projected as query q, L may denote the length of coarse features. The textual prototypes \hat{t} may be projected into key k and value v.

The attention mechanism may compute similarity scores between coarse features and textual prototypes using:

$$A = Softmax ( \frac{q \times {k}^{T}}{α} ) \qquad ( 4 )$$

$$\text{?} = {f}_{i} + A \times v$$

where [symbol] may denote the output feature and a may be a learnable scaling parameter to control the magnitude of the dot product of q and k before applying the softmax function. Similar to the conventional attention, the refined feature [symbol] may be fed into a Feed-Forward Network (FFN).

This textual-aware refinement may act as a general assignment of each pixel feature to the K textual prototypes. The coarse features may be updated via the weighted aggregation of textual prototypes, encouraging semantic grouping of regions that may belong to the same class. This mechanism may improve generalizable semantics by guiding visual representations with domain-invariant textual semantics.

Contextual Alignment: After enhancing the coarse features through text-aware refinement, a contextual alignment stage may be introduced to establish class-level correspondence between pixel features and text representations within the CLIP embedding space. A transformer decoder with N masked attention layers may be employed to iteratively update the initial textual queries Qₜ∈R^{K×Ĉ}, producing refined queries [symbol] ∈R^{K×Ĉ} that may incorporate spatial context from the coarse features. After normalization, the contextual correlation feature map \hat{F}_{c}∈R^{H×W×K} may be computed by performing a dot product between the pixel features \tilde{F}_{c}∈R^{H×W×Ĉ} and the refined textual queries [symbol] . This feature may map encode the semantic affinity between each spatial location and the corresponding textual concepts, which may enable textual aligned visual representations for following coarse-level feature matching.

The entire pipeline may be trained end-to-end by supervising the coarse and refinement matching modules separately.

Coarse-Level Matching Supervision: Visual coarse matches M_{c} may be established based on the correlation score matrix S_{c} of refined coarse features

$${\tilde{F}}_{c}^{A}$$

$$and$$

$${\tilde{F}}_{c}^{B}$$

The dual-softmax operation may then be applied followed by the mutual-nearest neighbor (MNN)) constraint. For coarse matching supervision, ground-truth correspondences

$${M}_{c}^{gt}$$

may be generated by warping grid-level points from image I_{A} to image I_{B} using known camera poses and depth maps, following the standard procedure in prior works. The resulting coarse correlation score matrix S_{c} may then be supervised using a negative log-likelihood loss:

$${L}_{c}^{v} = - \frac{1}{{N}_{c}} {\sum }_{( i , j ) ∈ {M}_{c}^{gt}} {log S}_{c} ( i , j ) \qquad ( 5 )$$

where N_{c} may denote the total number of coarse-level matches. Furthermore, another negative loglikelihood loss

$${L}_{c}^{t}$$

may be adopted for textual coarse correlation score matrix

$${S}_{c}^{t} ,$$

which may be built on contextual correlation feature maps

$${\tilde{F}}_{c}^{A}$$

$$and$$

$${\tilde{F}}_{c}^{B}$$

The overall coarse-level loss may be denoted as:

$${L}_{c} = {L}_{c}^{v} + {L}_{c}^{t} .$$

Fine-Level Matching Supervision: The fine-level matching module may be trained in two stages, each with its own supervision strategy. In the first stage, the fine-level local score maps Sₗ may be supervised using a negative log-likelihood loss L_{f1}, which may encourage high confidence at ground-truth fine match locations—similar to the coarse-level supervision. In the second stage, a regression loss L_{f2}, may be applied that may minimize the L₂ distance between the predicted sub-pixel coordinates M_{f} and their corresponding ground-truth positions

$${M}_{f}^{gt} ,$$

ensuring precise and accurate match localization.

The total loss may be the weighted sum of all supervisions: L=L_{c}+αL_{f1}+βL_{f2}.

In this section, the performance of our TextFM may be compared with the state-of-art methods on several domain generalized tasks, including two-view geometry and visual localization. Furthermore, the effectiveness of the present design may be evaluated by conducting detailed ablation studies.

DINOv2 may be adopted as a default VFM pretrain, and the number of classes K may be set to 150 based on ADE20K settings. The textual-aware refinement blocks may be interleaved for M=4 times using efficient attentions, while the transformer decoder may consist of N=3 layers with masked attention. The present model may be trained on the large-scale outdoor dataset MegaDepth, in which the highest dimension of the image may be resized to 800. The loss function's weight α and β may be set to 1.0 and 0.25, respectively. The AdamW optimizer may be used with an initial learning rate of 4×10⁻³. The model trained on MegaDepth may be used to evaluate all datasets and tasks to demonstrate the generalization ability.

Datasets: To demonstrate the effectiveness of the present method, not only may the outdoor MegaDepth dataset and indoor ScanNet dataset be used, but a synthetic day-night matching dataset may be built, Megadepth-Sync, for a more comprehensive evaluation of the generalization capability across challenging domains.

MegaDepth Dataset: The MegaDepth dataset may comprise sparse 3D reconstructions from 196 outdoor scenes and may present challenges such as large viewpoint variations and repetitive structures. For evaluation, the test split may be used, which may sample 1500 image pairs. To ensure consistency, images may be resized so that the longest edge may be 1200 pixels for all semi-dense and dense methods, while sparse methods may receive images resized to a longest edge of 1600 pixels.

ScanNet Dataset: The ScanNet dataset may include 1613 indoor RGB-D sequences with ground-truth depth and camera pose annotations. It may feature challenges such as significant viewpoint shifts and low-texture regions. The evaluation protocol may be adopted, using their sampled 1500 test pairs. All images may be resized to 640×480 resolution for fair comparison across methods.

MegaDepth-Sync Dataset: MegaDepth-Sync may be introduced, a synthetic benchmark designed to evaluate domain generalized feature matching under severe illumination changes. It is constructed by translating day-time images from the MegaDepth dataset into dark domain using a state-of-the-art image-to-image translation model. Specifically, this translation to the same 1,500 image pairs used in the MegaDepth test set may be applied, resulting in two evaluation subsets: (1) night-to-day matching and (2) night-to-night matching. All evaluation protocols and settings may be consistent with those of the original MegaDepth benchmark.

Baselines: The present TextFM may be compared with sparse matchers including LightGlue and OmniGlue (DINOv2). The semi-dense matchers may consist of LOFTR, MatchFormer, TopicFM and EfficientLoFTR. A series fully dense method producing dense warp may also be included (e.g., DKM and ROMA (DINOv2)).

Evaluation Protocols: Following prior methods, matching accuracy may be evaluated with the recovered relative poses derived from the estimated correspondences. The pose error may be defined as the maximum angular deviation between predicted and ground-truth rotation and translation. The Area Under the Curve (AUC) of the pose error may be reported at thresholds of 5°, 10°, and 20°.

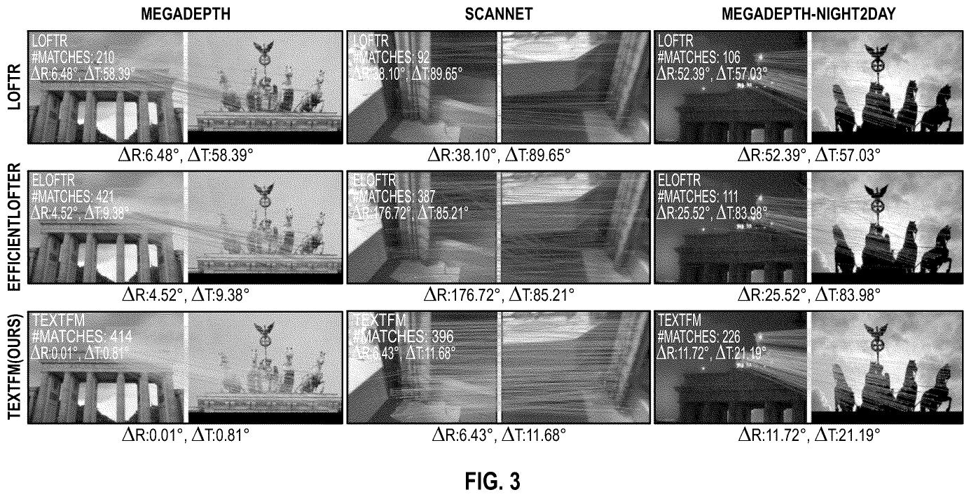

As presented in Table 1 below, the present method may outperform all sparse and semi-dense methods on outdoor datasets. Besides in-domain testing results, cross-domain generalization results may be reported by evaluating MegaDepth pretrained models on ScanNet and Megadepth-night2 day. Table 2 and Table 3 below may show the AUC results that the present outdoor model may demonstrate high accuracy on out-of-domain scenarios. Notably, FIG. 3 may demonstrate the generalizability of the present model across datasets.

TABLE 1
Comparisons of results on the MegaDepth(In-domain).
Measured in AUC of pose error at different thresholds
(higher is better). The best results are shown in bold.

| Category | method | AUC@5° | AUC@10° | AUC@20° |
|---|---|---|---|---|
| Sparse | LightGlue | 47.6 | 64.8 | 77.9 |
| | OmniGlue(DINOv2) | 47.4 | 65.0 | 77.8 |
| Semi-dense | LoFTR | 52.5 | 68.7 | 80.8 |
| | MatchFormer | 52.1 | 69.2 | 81.7 |
| | TopicFM | 54.1 | 70.1 | 81.6 |
| | EfficientLoFTR | 55.3 | 71.4 | 83.1 |
| | Ours(CLIP) | 57.1 | 72.9 | 83.9 |
| | Ours(DINOv2) | 58.0 | 73.6 | 84.6 |
| Dense | DKM | 60.4 | 74.9 | 85.1 |
| | ROMA(DINOv2) | 62.4 | 76.4 | 86.2 |

TABLE 2
Comparisons of results on the ScanNet(Out-of-domain).
Measured in AUC of pose error at different thresholds
(higher is better). The best results are shown in bold.

| Category | method | AUC@5° | AUC@10° | AUC@20° |
|---|---|---|---|---|
| Sparse | LightGlue | 15.2 | 32.1 | 49.0 |
| | OmniGlue(DINOv2) | 14.5 | 30.3 | 47.1 |
| Semi-dense | LoFTR | 16.9 | 33.6 | 50.6 |
| | MatchFormer | 15.8 | 32.0 | 48.0 |
| | TopicFM | 17.3 | 35.5 | 50.9 |
| | EfficientLoFTR | 18.4 | 35.6 | 52.7 |
| | Ours(CLIP) | 21.8 | 40.3 | 57.2 |
| | Ours(DINOv2) | 22.7 | 43.2 | 59.9 |
| Dense | DKM | 26.5 | 47.0 | 64.1 |
| | ROMA(DINOv2) | 28.8 | 50.4 | 68.1 |

TABLE 3
Comparisons of results on the MegaDepth-night2day (Out-of-domain).
Measured in AUC of pose error at different thresholds (higher is better).
The best results are shown in bold.

| Category | method | AUC@5° | AUC@10° | AUC@20° |
|---|---|---|---|---|
| Sparse | LightGlue | 44.8 | 62.1 | 72.9 |
| | OmniGlue(DINOv2) | 45.4 | 62.3 | 73.7 |
| Semi-dense | LoFTR | 44.9 | 61.8 | 73.5 |
| | MatchFormer | 45.6 | 62.4 | 74.8 |
| | TopicFM | 46.3 | 63.0 | 75.9 |
| | EfficientLoFTR | 47.5 | 64.7 | 77.8 |
| | Ours(DINOv2) | 48.5 | 66.1 | 79.3 |
| Dense | DKM | 52.0 | 67.8 | 81.2 |
| | ROMA(DINOv2) | 53.3 | 69.7 | 82.3 |

Visual localization may be a key downstream application of image matching that estimates the 6-DoF pose of query images relative to a 3D scene model. To validate the effectiveness of the present approach, it may be evaluated on two widely used benchmarks: the InLoc dataset and Aachen v1.1. The InLoc dataset may feature indoor environments characterized by repetitive structures and textureless surfaces, with each database image paired with a depth map. In contrast, Aachen v1.1 may be an outdoor dataset designed for challenging scenarios involving wide viewpoint variations and day-night illumination shifts. The present method may be evaluated on the full localization track of Aachen v1.1 to demonstrate its robustness.

The open-source localization framework HLoc may be adopted for evaluation. For both datasets, the percentage of estimated poses within specified angular and translation error thresholds may be reported, consistent with the official benchmark protocols. In the InLoc dataset, results may be reported separately for the two test scenes, DUC1 and DUC2. For the Aachen v1.1 dataset, performance may be evaluated independently on the daytime and nighttime subsets.

As may be shown in Table 4 and Table 5 below, the present TextFM may achieve highest overall accuracy across both detector-based and detector-free methods on both InLoc and Aachen v1.1 datasets. Generally, the present method shows strong generalization ability in visual localization settings.

TABLE 4
Comparisons of visual localization results on the InLoc dataset.
The percentage of pose errors satisfying both angular and distance
thresholds is reported as (0.25 m, 2°)/(0.5 m, 5°)/(1.0 m, 10°).
The best results are shown in bold.

| method | DUC1 | DUC2 | mean |
|---|---|---|---|
| LightGlue | 49.0/68.7/80.8 | 55.0/74.8/79.4 | 67.95 |
| LoFTR | 47.5/72.2/84.8 | 54.2/74.8/85.5 | 69.83 |
| TopicFM | 52.0/74.7/87.4 | 53.4/74.8/83.2 | 70.92 |
| PATS | 55.6/71.2/81.0 | 58.8/80.9/85.5 | 72.17 |
| EfficientLoFTR | 52.0/74.7/86.9 | 58.0/80.9/89.3 | 73.63 |
| Ours(DINOv2) | 52.6/74.7/87.0 | 58.4/81.2/89.2 | 73.85 |

TABLE 5
Comparisons of visual localization results on the Aachen
v1.1 dataset. The percentage of pose errors satisfying
both angular and distance thresholds is reported as
(0.25 m, 2°)/(0.5 m, 5°)/(1.0 m, 10°). The best results
are shown in bold.

| method | Day | Night | mean |
|---|---|---|---|
| LightGlue | 90.2/96.0/99.4 | 77.0/91.1/100.0 | 92.28 |
| LoFTR | 88.7/95.6/99.0 | 78.57/90.6/99.0 | 91.90 |
| TopicFM | 90.2/95.9/98.9 | 77.5/91.1/99.5 | 92.18 |
| PATS | 89.6/95.8/99.3 | 73.8/92.1/99.5 | 91.68 |
| EfficientLoFTR | 89.6/96.2/99.0 | 77.0/91.1/99.5 | 92.07 |
| Ours(DINOv2) | 89.6/96.2/99.1 | 79.8/92.0/99.5 | 92.70 |

A detailed ablation study may be conducted evaluating the contributions of each component in TextFM on Megadepth dataset. Based on the default EfficientLoFTR, a baseline may be adopted using a FPN as the feature backbone. Components of TextFM may then be sequentially introduced and evaluated in terms of AUC. As shown in Table 6 below, the LoRA finetuned DINOv2 backbone may offer the most improvement based on the baseline model.

TABLE 6
Ablations about the key components of our TextFM on the
MegaDepth. Each Component is sequentially incorporated.
Measured in AUC of pose error at different thresholds
(higher is better). The best results are shown in bold.

| method | AUC@5° | AUC@10° | AUC@20° |
|---|---|---|---|
| Baseline | 55.5 | 71.6 | 83.1 |
| +LoRA fineumed DINOv2 | 56.8 | 72.8 | 83.9 |
| +Physical Priors | 57.1 | 73.0 | 84.1 |
| +Textual-aware Refinement | 57.6 | 73.4 | 84.4 |
| Our TextFM | 58.0 | 73.6 | 84.6 |

The present TextFM is a first language-guided image matching framework that may integrate domain-invariant semantic priors from textual embeddings into a detector free, coarse-to-fine semi-dense matching pipeline. By introducing instance-level textual queries derived from VLMs, TextFM may enhance coarse feature discriminability and improve estimation robustness under domain shifts and challenging visual conditions. Additionally, robust visual features may be extracted derived from illumination-invariant physical priors, fused with coarse-level features adapted from vision foundation models (VFMs). A LoRA-based adaptation scheme may be adopted for more efficient task-specific finetuning VFMs while preserving pretrained knowledge, improving generalization and reducing overfitting compared to prior approaches that directly fuse frozen VFM features. Furthermore, Megadepth-Sync, a day-night matching benchmark with high-quality synthetic day-night image pairs with ground-truth poses, to enable rigorous evaluation of feature matching robustness under extreme illumination changes may be provided. Extensive experiments may show that the proposed TextFM not only consistently outperforms state-of-the-art semi-dense feature matching methods across variety domains, but may yield improvement on day-night shifts.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A method for language-guided image matching using domain-invariant semantic information from vision-language models (VLMs) comprising:
generating instance-level textual queries using text embeddings, wherein each instance-level textual query acts as a class specific prototype to group and feature regions corresponding to a same class; and
extracting multi-scale visual features from illumination-invariant physical priors, fused with coarse-level features adapted from vision foundation models (VFMs).

2. The method of claim 1, comprising generating a day-night matching benchmark having synthetic day-night image pairs with ground-truth poses to enable evaluation of model robustness under differing illumination changes.

3. The method of claim 1, wherein generating the instance-level textual queries comprises generating the instance-level textual queries using text embeddings of class names and learnable prompts.

4. The method of claim 1, wherein extracting multi-scale visual features comprises using a convolutional neural network (CNN) based featured pyramid network (FPN) with physical priors and the VFMs.

5. The method of claim 1, comprising enhancing the coarse-level features to compute a matching probability distribution via a language-guided module, wherein coarse correspondences are selected using mutual nearest neighbor (MNN) matching.

6. The method of claim 5, comprising refining a position for each coarse-level feature match by evaluating feature similarity between a query patch and a localized search window.

7. The method of claim 1, comprising calibrating the VFMs for the coarse-level feature extraction using a low-rank adaptation (LoRA) mechanism.

8. The method of claim 7, comprising installing trainable low-rank matrices into each layer of the VFM allowing adaptation of the coarse-level features.

9. The method of claim 1, comprising:
generating the illumination invariant physical priors from input images; and
using a feature pyramid network (FPN) to extract the multi-scale visual features.

10. The method of claim 1, comprising:
utilizing a pre-trained VLM as a text encoder to generate the text embeddings;
injecting contextual semantics into each pixel-level feature by integrating text embeddings through cross-attention before each self- and cross-attention block; and
establishing class-level correspondence between pixel features and text representations using a transformer decoder with N masked attention layers to iteratively update initial textual queries producing refined queries that incorporate spatial context from the coarse-level features.

11. The method of claim 10, comprising freezing the encoder during training to retain contextual semantic and generalization capabilities.

12. The method of claim 10, comprising computing a contextual correlation feature map by performing a dot product between the pixel-level features and the refined queries to encode a semantic affinity between each spatial location and corresponding textual concepts enabling textual aligned visual representations.

13. The method of claim 6, comprising supervising the coarse-level feature match and refinement matching separately.

14. A method for language-guided image matching using domain-invariant semantic information from VLMs, the method implemented using a computer system including a processor communicatively coupled to a memory device, the method comprising:
generating instance-level textual queries using text embeddings of class names and learnable prompts, wherein each instance-level textual query acts as a class specific prototype to group and feature regions corresponding to a same class;
extracting multi-scale visual features from illumination-invariant physical priors, fused with coarse-level features adapted from VFMs, wherein the VFMs are calibrated for the coarse-level feature extraction using a LoRA mechanism;
enhancing the coarse-level features to compute a matching probability distribution via a language-guided module, wherein coarse correspondences are selected using mutual nearest neighbor matching; and
refining a position for each coarse-level feature match by evaluating feature similarity between a query patch and a localized search window.

15. The method of claim 14, comprising generating a day-night matching benchmark having synthetic day-night image pairs with ground-truth poses, to enable evaluation of model robustness under differing illumination changes.

16. The method of claim 14, wherein extracting multi-scale visual features comprises using a convolutional neural network based featured pyramid network with physical priors and the VFMs.

17. The method of claim 14, comprising installing trainable low-rank matrices into each layer of the VFM allowing adaptation of the coarse-level features.

18. The method of claim 14, comprising:
generating the illumination invariant physical priors from input images; and
using a feature pyramid network to extract the multi-scale visual features.

19. The method of claim 14, comprising:
utilizing a pre-trained VLM as a text encoder to generate the text embeddings;
injecting contextual semantics into each pixel-level feature by integrating text embeddings through cross-attention before each self- and cross-attention block; and
establish class-level correspondence between pixel features and text representations using a transformer decoder with N masked attention layers to iteratively update initial textual queries producing refined queries that incorporate spatial context from the coarse-level features.

20. A method for language-guided image matching using domain-invariant semantic information from VLMs, comprising:
generating instance-level textual queries using text embeddings of class names and learnable prompts, wherein each instance-level textual query acts as a class specific prototype to group and feature regions corresponding to a same class;
extracting multi-scale visual features using a CNN based FPN from illumination-invariant physical priors, fused with coarse-level features adapted from VFMs, wherein the VFMs are calibrated for the coarse-level feature extraction using a LoRA mechanism that inserts trainable low-rank matrices into each layer of the VFM allowing adaptation of the coarse-level features;
enhancing the coarse-level features to compute a matching probability distribution via a language-guided module, wherein coarse correspondences are selected using mutual nearest neighbor matching;
refining a position for each coarse-level feature match by evaluating feature similarity between a query patch and a localized search window; and
generating a day-night matching benchmark having synthetic day-night image pairs with ground-truth poses, to enable evaluation of model robustness under differing illumination changes.
